(19) United States
(12) Patent Application Publication
(10) Pub. No.: US 2006/0031118 A1
(43) Pub. Date: Feb. 9, 2006

(54) Method and system for locating a service by an electronic device

(76) Inventor: Robert P. Morris, Raleigh, NC (US)

Correspondence Address: IPAC, 111 Corning Road, Suite 220, Cary, NC, 27511, US

(21) Appl. No.: 10/913,071

(22) Filed: Aug. 6, 2004

(51) Int. Cl. G06Q 30/00

(52) U.S. Cl. 705/14

(57) ABSTRACT

In a first aspect, the present invention is a method that includes specifying a request for a service, where the request is related to at least one of a plurality of contexts, receiving in the electronic device advertising information related to an offered service, and presenting the advertising information to a user of the electronic device if the offered service matches the request and its related context, whereby the advertising information is presented to the user in a manner corresponding to the at least one context. In a second aspect, the present invention is a system that includes a computer system associated with at least one service provider that is coupled to a network and includes at least one advertiser for transmitting over the network advertising information related to each of the at least one providers. The system also includes an electronic device that is coupled to the network. The electronic device is capable of specifying a request for a service, wherein the request is related to at least one of a plurality of contexts, and includes a locator for processing the request and for locating advertising information related to the service matching the request and its related contexts, and a display for displaying to a user of the electronic device the advertising information related to the matching service.

### FIELD OF THE INVENTION

The present invention relates to electronic devices, and more particularly to locating context sensitive services by and for an electronic device.

### BACKGROUND OF THE INVENTION

For all the benefits offered by electronic computing devices, a number of problems still remain. Among these problems are:
locating a particular software application or feature when needed on a device
integrating functions or features across software applications or components
retrieving information relevant to a particular task
   Locating Needed Applications and Features

In many instances, locating an application or feature in an electronic device is difficult or intimidating for users. Thus, users often do not utilize these applications and features on their electronic devices. Moreover, if an application or feature is not included in the start menu or visible on the device's display, e.g., on the desktop for a personal computer (PC), some users will not be aware that the feature or application exists. This situation is compounded for handheld devices because navigation is more difficult given the limited input capabilities of handheld devices. Not surprisingly, many software applications and features are never discovered, much less located and used.

In a network environment, most users are familiar with browsers and have learned how to use standard search facilities to find information and services. Nevertheless, most search engines return references that contain the search terms and the search results are often not what the user desires and/or the number of “hits” returned is so large, that only a tiny fraction of the results can be explored before the user gives up in frustration.

In one approach to alleviating some of these concerns, the user submits a request for services or goods to a third party “concierge” that optionally determines the geographical location of the user's device, using for example GPS or some other triangulating technique. The concierge queries a database to determine merchants providing the requested services or goods in the device's vicinity. The quality of the service, however, depends on the quality of the database. Because a fee is typically charged to have a listing in the database, some merchants will choose not to list. Another disadvantage of such a service is that the database server is a single point of failure, so that if the database server is not accessible, the service is unavailable.

Integrating Functions Across Applications

Users often find when performing a task using a particular application that they need a feature not supported by the application but found in another application. For example, an image viewing application on a personal computer allows a user to upload and view images taken by a digital camera, but does not allow the user to create a greeting card from an image. If a second application includes this feature, the user typically must close the image viewing application, find and use the second application, and then reopen and return to the first application. Often, the data must be converted before either application can be utilized because the data formats are incompatible. Because software applications generally are not inter-dependent, the industry produces tightly integrated applications with a plurality of features. While this bundling of services might be advantageous for software producers, it is less than desirable for the user because large software packages that contain the desired feature along with a plurality of redundant features must be stored on the device.

One approach to alleviating this problem involves providing a directory service that allows a software component to search a directory for a compatible component to provide a specific function. The deficiency in this approach, however, is that the software component typically searches for a fixed set of functions only. Thus, the software component cannot take advantage of new functions and features that may be added to the directory because it has no capacity to discover such features.

Retrieving Information Relevant to a Particular Task or to Data.

Some context sensitive help is generally provided by applications. While such help is specific to the task being performed, it is not sensitive to the data the task is using. On the Internet, web pages provide links to related resources and services. Nevertheless, the web page controls what resources and services are provided. Resources that may be relevant to the user, but not provided by the serving web site, are not available to the user.

Providers of information, resources, and products currently use email advertising, web advertising, and broadcast and print advertising to inform users of their services. Nevertheless, these advertising means are often not welcomed by the user because they do not appear in a context the user needs, and are often regarded as annoying spam or junk mail.

Accordingly, there exists a need for a system and method which allows service, product, and information providers (collectively referred to as “providers”) to advertise their availability in a context welcomed by the user. The system and method should allow providers to present their offerings in a timely context and in a context where it is needed. The system and method should also enable software components in the electronic device to advertise their services to the user and to make use of services of other software components. The present invention addresses such a need.

### BRIEF SUMMARY OF THE INVENTION

The present invention is directed to a method and system for locating a service by an electronic device. In a first aspect, the present invention is a method that includes specifying a request for a service, where the request is related to at least one of a plurality of contexts, receiving in the electronic device advertising information related to an offered service, and presenting the advertising information to a user of the electronic device if the offered service matches the request and its related context, whereby the advertising information is presented to the user in a manner corresponding to the at least one context.

In a second aspect, the present invention is a system that includes a computer system associated with at least one service provider that is coupled to a network and includes at least one advertiser for transmitting over the network advertising information related to each of the at least one providers. The system also includes an electronic device that is coupled to the network. The electronic device is capable of specifying a request for a service, wherein the request is related to at least one of a plurality of contexts. The device includes a locator that processes the request and locates advertising information related to the service matching the request and its related contexts, and a display for displaying to a user of the electronic device the advertising information related to the matching service.

In a third aspect, the present invention is a system that includes a computer system associated with at least one service provider, where the computer system is coupled to a network and includes at least one advertiser for transmitting over the network advertising information related to a service offered by each of the at least one service providers. The system also includes a gateway server coupled to the network and a handheld electronic device that is capable of accessing the gateway server. The handheld electronic device is capable of specifying a request for a service, where the request is related to at least one of a plurality of contexts. The electronic device transmits the request to the gateway server. The gateway server further includes a locator that processes the request and locates advertising information related to the service matching the request and its related context. A display in the handheld electronic device displays the advertising information related to the matching service such that the advertising information is presented to a user of the handheld device in a manner corresponding to the at least one context.

According to the method and system disclosed herein, the present invention allows the user of the electronic device to locate, collect and organize by appropriate contexts advertising information regarding services and products that can be utilized by the user, by the electronic device, or by software components running on the electronic device. Because advertisers transmit their information independently, each advertiser is allowed to present the information as it wishes. Moreover, advertisers can present their products and services through their own local networks or through a shared network, thereby eliminating the need (and the associated expense) for a third party directory service.

### BRIEF DESCRIPTION OF SEVERAL VIEWS OF THE DRAWINGS

FIG. 1 is a block diagram illustrating a network environment that can be utilized according to a preferred embodiment of the present invention.

FIG. 2 is a flowchart describing a process for locating context sensitive advertising information according to a first preferred embodiment of the present invention.

FIG. 3 is a flowchart illustrating a process for locating context sensitive advertising information according to a second preferred embodiment of the present invention.

FIG. 4 is block diagram illustrating a format for a request for context sensitive advertising information according to a preferred embodiment of the present invention.

FIG. 5 is a block diagram illustrating a format for advertising information from a provider according to a preferred embodiment of the present invention.

FIG. 6 is a block diagram illustrating information in the reference according to a preferred embodiment of the present invention.

### DETAILED DESCRIPTION OF THE INVENTION

The present invention relates to electronic devices, and more particularly to locating context sensitive services by and for an electronic device. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

According to a preferred embodiment of the present invention, an electronic device, such as a personal computer, PDA, or mobile phone, includes or has access to a locator, which allows a user of the device to locate context sensitive services and products that can be utilized by the user, by the device, or by a software component running on the device. Service or information providers use a network to provide advertising information about the services and information offered by the providers to the locator. The locator receives the advertising information and, if appropriate, displays a reference to the associated provider to the user.

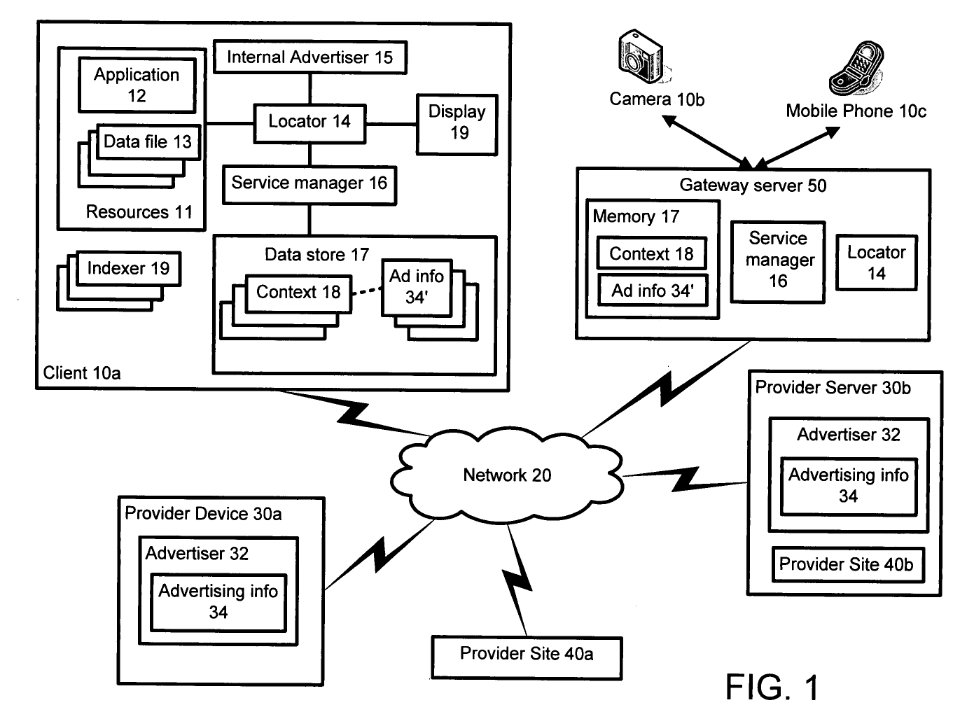

FIG. 1 is block diagram illustrating a network environment in which the preferred embodiment of the present invention can be implemented. As is shown, a plurality of client devices 10a-10b are coupled to a network 20, such as the Internet or a local area network (LAN). Some client devices 10b, 10c are coupled to the network 20 via a gateway server 50. These devices 10b, 10c typically connect to the network 20 sporadically and/or have limited storage and operating capacity. Thus, the gateway server 50 controls these devices and gives them access to a larger network environment.

According to a preferred embodiment of the present invention, a client device, such as a PC 10a, includes resources 11, such as applications or software components 12 and data files 13, and a locator 14, which is preferably a software application that is capable of interacting with the device's 10a communication interface (not shown). Alternatively, the locator 14 can reside in a proxy server, e.g., gateway server 50, accessible by the client device 10b, 10c. When activated by a user of the client device 10a, an application 12 can locate services and information relevant to the application's operation and/or relevant to the data file 13 on which it is operating by issuing requests to the locator 14.

In a preferred embodiment, the client device 10a includes a plurality of indexers 19 for parsing data in the data files 13 so that requests for information related to the data can be generated. Alternatively, the indexers 19 can reside in the proxy server 50. An indexer 19 is preferably provided for and is compatible with a file format, e.g., a PDF indexer 19 parses PDF files 13.

The locator 14 processes the requests, and locates advertising information 34 associated with services and information satisfying the requests. The locator 14 locates advertising information 34 by accessing the network 20. The locator 14 is enabled to receive advertising information 34 transmitted from one or more service providers via the network 20, and presents the advertising information 34 to the user while the user is utilizing the application 12.

According to a preferred embodiment of the present invention, the locator 14 is coupled to a service manager 16, which maintains advertising information 34′ received by the locator 14 in a data store 17. As is shown, the service manager 16 and data store 17 can reside with the locator 14 either in the client 10a or in the proxy server 50.

The service manager 16 organizes the advertising information 34′ by at least one context 18 in which the information is relevant. A context 18 may be subject based for information related to various subjects, e.g., the Golden Gate Bridge, food, sports, etc. The context 18 can be service based for services and/or information related to a particular task, e.g., printing, word processing, web browsing, etc. The context 18 can also be environment based for particular system environments, e.g., the device's 10a desktop, main menu, or the context 18 may be based on a particular application 12 or data file 13. These examples of contexts 18 are in no way limiting and those skilled in the art recognize that other types of contexts 18 are available.

Computer systems 30a, 30b associated with at least one service provider are also coupled to the client devices 10a-10c via the network 20. A computer system can be a provider device 30a dedicated to a service provider, while the provider server 30b can support at least one service provider and typically hosts one or more provider websites 40b. The provider device 30a and server 30b include at least one advertiser 32 associated with one or more service providers. The advertiser 32 maintains advertising information 34 for the associated service provider(s), and allows the associated provider to transmit its advertising information 34 to the client devices 10a-10c via the network 20.

In a preferred embodiment, an internal advertiser 15 is provided in the client device 10a, which advertises services and information available on the device 10a itself. The internal advertiser 15 allows the user to find or locate services residing within the client device 10a.

According to the preferred embodiment of the present invention, the client device 10a-10c or an application 12 in the client device 10a-10c can locate services and information relevant to its operation and/or relevant to the data on which the application 12 is operating by issuing a request to the locator 14. Alternatively, the application 12 can register with the locator 14 and provide information regarding its context(s). As state above, the locator 14 and the service manager 16 can reside in the client device 10a, or alternatively, can reside in a gateway server 50 accessible by client devices 10b, 10c that sporadically connect to the network 20 and/or have limited storage and operating capacity.

The locator 14 locates advertising information for services that match a given context via the internal advertiser 15, the external advertiser(s) 32 and the service manager 16. For example, if the user is using a word processor application 12 to edit a data file 13 related to the dosing of a particular drug, the locator 14 can locate for the word processing application 12 advertising information 34 for the following:
Remote print service
Local print service
Archive to department file server service
Links to information about drugs in the document the user is editing
Guidelines on how to write the type of document the user is writing
Operations related to the workflow process of which the document is a part
   Notably, the local print service is located through the internal advertiser 15, and the remaining services are located from external advertisers 32.

Depending on the context 18 to which the service is relevant, the information is presented in various ways. For example, the remote and local print services are added to the “File” menu in the application menu in a “Print” submenu; the “archive” service is presented through a menu item in the “File” menu along with the standard “Save” and “Save as . . . ” items; links to information about drugs are presented by converting the drug names in the document into hyperlinks for additional info or a context menu is provided when the user right-clicks on the drug name; guidelines for writing the document are presented in a menu item in the help menu; and operations related to workflow appear in a sibling window with instructions and form data associated with the next step in the process. The above described presentation format is merely exemplary and those skilled in the art would readily appreciate that the manner in which advertising information can be presented can vary.

In another example, the advertiser 32 can push advertising information 34 to the client device 10a. Consider the following scenario: the client device 10a and the provider server 30b are part of an enterprise where the user of the device 10a is an employee of the provider. The advertiser 32 can be updated daily with advertising information 34 related to task data specific for the employee/user. The locator 14 receives the advertising information 34 related to the employee from the advertiser 32 that includes a URL for the employee's task data. The advertising information 34 can indicate that an icon for the URL is to be placed on the device's 10a desktop (context) when the employee logs on so that the employee can view the day's task data when the employee selects the icon.

According to the present invention, locators 14 and advertisers 32 interact with one another in a number of ways that are dictated by the nature of the network 20. For example, if the network 20 is a LAN, locators 14 can broadcast requests over the network 20 and advertisers 32 can listen for the requests, and vice versa. If the network 20 is a large network, e.g., the Internet, the locators 14 can be configured with the addresses of one or more advertisers 32 and send requests directly to those addresses. This configuration may be a subscription service, such that the advertisers 32 send the advertising information 34 to the locators 14 without further requests. Alternatively, the advertisers 32 can be provided with the addresses of one or more locators 14 and send advertising information 34 directly to the locators 14 without any requests.

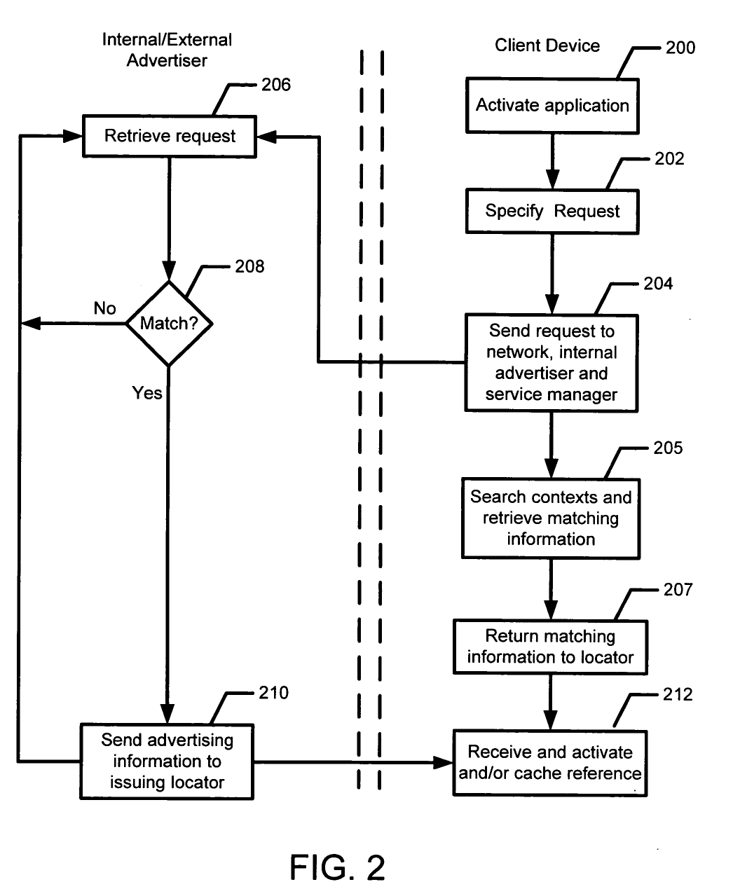

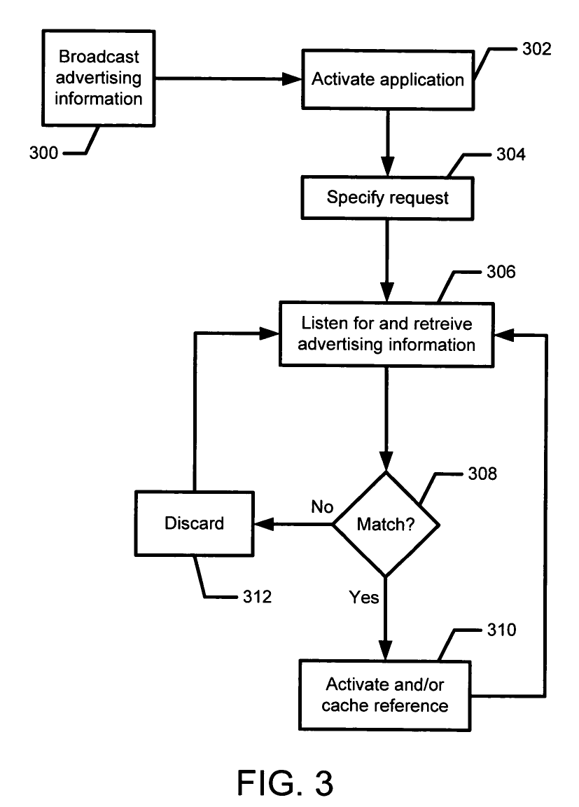

FIG. 2 and FIG. 3 are flowcharts illustrating how the locator 14 interacts with the internal advertiser 15 and external advertisers 32. FIG. 2 is flowchart describing a process for locating context sensitive information according to a first preferred embodiment of the present invention where the client device 10a-10c issues a request over the network 20.

Referring to FIG. 1 and FIG. 2, the process begins when the user activates the client device, e.g., 10a, or an application 12 in the client device (step 200). The user, or alternatively the application 12, specifies a request for a particular type of service related to the application 12 or for information related to the data 13 used by the application 12 (step 202). Accordingly, the request is related to at least one context 18 that describes the application 12, the requested service, or the requested information.

For example, if the application 12 is an image viewing application 12, and the application 12 is displaying an image of the Golden Gate Bridge, the request would be related to the context 18 for the image viewing application 12 and the context 18 related to famous bridges. The request can specify: locating a compatible service for creating a postcard from the image, locating historical information about the bridge, or locating driving directions to the bridge. Each specification of the request is related to a context 18. Thus, the request itself can be related to a plurality of contexts 18.

In addition, some requests can also be “preconfigured” for the client device 10a or for the user. Such a request is a standing request that is issued by the locator 14 automatically and does not originate from the user or from an application 12.

Once the request is specified, the locator 14 proceeds to locate information about the requested service or information. In this embodiment, the locator 14 sends the request to the network 20, to the internal advertiser 15 and to the service manager 16 (step 204). The request sent to the network 20 is preferably broadcasted in a manner that is specific to the network type, e.g., to a well-known or configured broadcast address. In another preferred embodiment, the request is sent to a well-known or configured address for the network 20 or for the advertiser 32. In yet another embodiment, the request is addressed to any address, but intercepted by a proxy (not shown) that processes the request. Alternative methods for broadcasting the request will be apparent to those skilled in the art, and the scope of the present invention is not intended to be limited by those discussed above.

In the meantime, the internal advertiser 15 and external advertiser(s) 32 are continuously listening for requests. When the client device 10a sends the specified request (step 204), the advertisers 15, 32 identify and retrieve the request (step 206). In a preferred embodiment, the request is formatted in such a way that the advertisers 15, 32 are able to identify the request by its formatting.

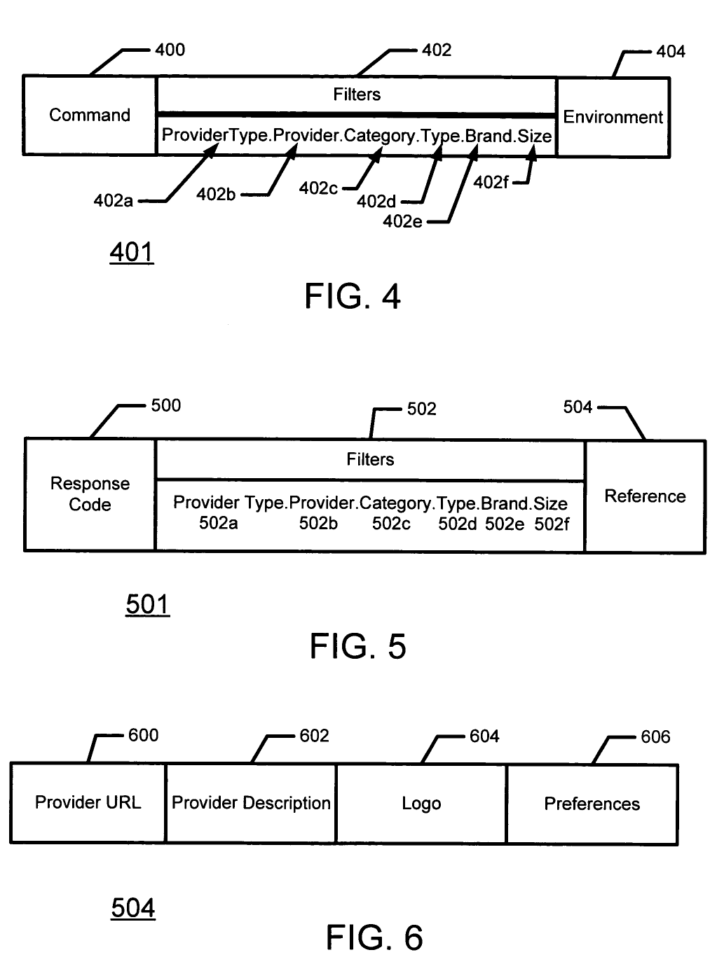

FIG. 4 is a block diagram illustrating a format for the request 401 according to a preferred embodiment of the present invention. As is shown, the request 401 includes a command section 400, a filter section 402 and a description of the environment 404 for the device 10a or the application 12 that issued the request. The command 400 identifies the message as a request 14, and is preferably a character string such as: “Locate service”, “Locate information” or “Locate context.” The format is extensible and, thus, supports additional commands.

The filters section 402 specifies the information or service desired and defines the one or more contexts associated with the request 401. In one embodiment, the filters section 402 includes a plurality of character strings separated by a delimiter, such as a period. Alternatively, the filters can utilize an XML format, or an SQL like syntax. Each of the character strings represents a context describing the information or service. For example, a first string specifies the provider type context 402a, e.g., “Printing”, “Cleaner”, “Hardware”, etc. The provider type 402a can be followed by a specific provider context 402b, e.g., “Kinkos”, etc. Next an information or service context 402c can be specified, e.g., “Food”, “Paper”, “Pants”, and a type 402d, which further limits the information or service context 402c. The actual content of the filters may vary depending on the service or data being requested.

The environment section 404 of the request format 401 includes information about the client device's 10a capabilities and operating environment context. In one embodiment this section 404 includes keyword/value pairs that describe the environment. For example, the following keyword/value pairs: os=symbian; display=true; color=true; GUI=true; browser=true; indicate that the device includes a Symbian operating system, has a color display, and supports a browser. This information can be utilized by the advertisers 15, 32 to customize the advertising information 34 it returns in response to the request.

Referring again to FIG. 2, once the request has been received, the advertisers 15, 32 determine whether the service or product offered by the associated provider(s) match the request and its contexts (step 208). If a match is determined, the advertiser, e.g., 32, sends advertising information 34 associated with the matching provider to the locator 14 in the client device 10a (step 210).

FIG. 5 is a block diagram illustrating a format for the advertising information 501 according to a preferred embodiment of the present invention. The advertising information 501 is formatted to complement the request 401, and includes a response code 500, a filters section 502 and a reference 504.

The response code 500 includes information allowing the locator 14 to match the response 501 to an associated request 401. The filters section 502 specifies the information or service offered by the provider similarly to how the request 401 specifies the information or service desired.

The reference 504 includes information related to the provider. FIG. 6 is a block diagram illustrating information in the reference 504 according to a preferred embodiment of the present invention. As is shown, the reference 504 includes one or a combination of the following: an address or URL 600 for the provider; a description of the service(s) or information offered 602, an icon or logo 604, and presentation/display preferences 606.

The provider URL 600 preferably allows a potential customer to access the provider, and may be provided in any number of formats. For example, the URL 600 may refer to the provider's web page, a street address, a downloadable executable, etc. The advertisers 15, 32 may provide different URLs to different devices depending on the information provided by each device. The description 602 is a text block, or alternatively, a URL that references the content of the section. Similarly, the logo section 604 includes an icon and/or includes a URL that identifies a location from which the icon is retrieved.

The preferences section 606 describes how the advertising information 34 should be displayed on the client device 10a, and preferably includes keyword/value pairs. For example, consider the following keyword/value pairs: desktop=true; icon=true; flyover=true. These preferences indicate that the provider requests that the device 10a display the icon on the device's desktop, and that it display the description when the device Ul's focus is on the icon. If the user selects the icon and a URL has been provided, the URL is accessed by the device 10a. Other preferences include keywords which allow the merchant to request a menu item be added to the device main menu, or to request that a control, such as button, be added to the browser's toolbar on the device.

It should be apparent to those skilled in the art that the request 401 and advertising information 501 formats described above are exemplary and that equivalent formats are available which would provide the same capabilities. Accordingly, the principles of the present invention should be construed to encompass those equivalent formats.

Referring again to FIG. 2, the locator 14 sends the request to the advertisers 15, 32 and to the service manager 16. As the advertisers 15, 32 are retrieving the request and determining whether there is a match (steps 206 and 208), the service manager 16 accesses the data store 17 and searches the contexts 18 for advertising information 34′ previously stored therein matching the request and its contexts (step 205). Matching advertisement information 34′ is retrieved and returned to the locator 14 (step 207).

After the advertisers 15, 32 send the matching advertising information 34 to the locator 13 (step 210), and after the service manager 16 returns the matching information 34′ (step 207), the locator 14 receives and activates and/or caches the reference(s) 504 (step 212). In a preferred embodiment, the locator 14 and or requesting application 12 displays the reference(s) 504 according to the user's preferences, the device's 10a capabilities, and the display preferences of the provider 606, if provided. As stated above, the request 401 can include the client device's capabilities and the user's preferences 404 (FIG. 4) so that the advertisers 15, 32 can customize the reference(s) 504.

FIG. 3 is a flowchart illustrating a process for locating advertising information according to a second preferred embodiment of the present invention where the external advertisers 32 transmit advertising information 34 over the network 20. Referring again to FIG. 1 and FIG. 3, the external advertisers 32 are continuously or periodically transmitting advertising information 34 onto the network (step 300). In a preferred embodiment, the advertising information 34 includes the reference 504 to the provider, as discussed above. Next, the user activates an application 12 (step 302), and specifies a request for a particular type of service related to the application 12 or for information related to the data 13 used by the application 12 (step 304), as described above in step 202 of FIG. 2. In this mode, the filters section 402 of the request 401 (FIG. 4) is used to filter advertising information 34.

Once the request is specified, the locator 14 proceeds to locate information about the requested service or information in the manner described in FIG. 2, but with one exception. In this embodiment, instead of sending the request to the network 20, the locator 14 listens for and retrieves advertising information 34 broadcasted by the external advertisers 32 (step 306). According to a preferred embodiment, the locator 14 identifies the advertising information 34 by analyzing the response code section 500 of the advertising information 501 (FIG. 5).

Once the locator 14 retrieves the advertising information 34 from the network 20, the locator 14 determines whether the service or information offered by the provider(s) matches the request and its contexts (step 308). If a match is not determined, the locator 14 discards the advertising information 34. If a match is determined, the locator 14 activates and/or caches the reference(s) 504 associated with the matched advertising information 34 (step 310). The locator 14 then listens for more advertising information 34 (step 306) and steps 306 through 310 are repeated. Although not depicted in FIG. 3, the locator 14 sends the request to the internal advertiser 15 and the service manager 17 to locate matching advertising information 34′, as described in FIG. 2.

Through aspects of the preferred embodiment of the present invention, an application 12 running on a client device 10a-10c may locate services and information relevant to its operation and/or relevant to the data it is operating on by issuing requests to its locator 14. The application 12 may also simply register with the locator 14 providing information about its context. The locator 14 locates advertising information that match the request and its contexts via internal and external advertisers 15, 32 and through its service manager 16. Service providers who provide such services and information can advertise their services as they wish in the manner in which they design their respective sites, and utilize their own networks or a shared network to broadcast their advertisements, thereby eliminating the need for a third party directory service.

A method and system for locating context sensitive information about a service has been disclosed. The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A method for locating information about a service by an electronic device comprising;
specifying a request for a service, wherein the request is related to at least one of a plurality of contexts;
receiving advertising information related to an offered service; and
presenting the advertising information to a user of the electronic device if the offered service matches the specified request and its related context,
whereby the advertising information is presented to the user in a manner corresponding to the at least one context.

2. The method of claim 1 further comprising issuing the request by one of a software component in the electronic device or the electronic device.

3. The method of claim 2 further comprising associating the software component with at least one of a plurality of contexts based on the component's functionality and operating environment.

4. The method of claim 1 further including providing a locator in the electronic device for processing the request and locating the matching advertising information.

5. The method of claim 4 wherein locating advertising information includes issuing the request over a network.

6. The method of claim 5 wherein locating advertising information further includes:
receiving the request by an advertiser coupled to the network;
determining whether a service offered by the advertiser matches the request and its related contexts; and
if the service offered by the advertiser matches the request, transmitting the advertising information related to the offered service to the locator in the electronic device via the network.

7. The method of claim 4 wherein locating advertising information includes issuing the request to an internal advertiser provided within the electronic device, wherein the internal advertiser maintains advertising information related to services offered by the electronic device.

8. The method of claim 7 wherein locating advertising information further includes:
determining whether a service offered by the electronic device matches the request and its related contexts; and
if the service offered by the electronic device matches the request, returning the advertising information related to the offered service to the locator.

9. The method of claim 4 further including:
associating the advertising information with at least one of the plurality of contexts based on the offered service; and
storing the advertising information with its associated contexts in a data store.

10. The method of claim 9, wherein locating advertising information includes accessing the data store and retrieving matching advertising information stored therein.

11. The method of claim 4 wherein locating advertising information includes listening to a network by the locator for advertising information, retrieving such information and determining whether the offered service matches the specified request and its contexts.

12. The method of claim 1 further including providing a proxy locator in a gateway server coupled to the electronic device, wherein the proxy locator is for receiving the request, processing the request and locating the matching advertising information.

13. The method of claim 12 further including:
associating the advertising information with at least one of the plurality of contexts based on the offered service; and
storing the advertising information with its associated contexts in a data store in the gateway server.

14. The method of claim 13, wherein locating advertising information includes accessing the data store and retrieving matching advertising information stored therein.

15. A system for locating a service for an electronic device comprising:
a computer system associated with at least one service provider, wherein the computer system is coupled to a network and includes at least one advertiser for transmitting over the network advertising information related to a service offered by each of the at least one service providers; and
an electronic device coupled to the network, comprising:
means for specifying a request for a service, wherein the request is related to at least one of a plurality of contexts;
a locator for processing the request and locating advertising information related to the service matching the request and its related contexts; and
a display for displaying to a user of the electronic device the advertising information related to the matching service,
wherein the advertising information is presented to the user in a manner corresponding to the at least one context.

16. The system of claim 15, wherein one of a software component in the electronic device or the electronic device specifies the request.

17. The system of claim 16 wherein the software component is associated with at least one of the plurality of contexts based on the component's functionality and operating environment.

18. The system of claim 15, wherein the locator connects the electronic device to the network and locates the matching service by issuing the request over the network.

19. The system of claim 18, wherein the at least one advertiser in the computer system receives the request, determines whether a service offered by any of the at least one providers matches the request, and if the service offered by any of the at least one providers matches the request, transmits the advertising information related to the offered service to the locator in the electronic device via the network.

20. The system of claim 15, wherein the electronic device further includes an internal advertiser that maintains advertising information related to services offered by the electronic device.

21. The system of claim 20, wherein the locator locates the matching service by issuing the request to the internal advertiser, which then determines whether a service offered by the electronic device matches the request and its related contexts, and if the service offered by the electronic device matches the request, returns the advertising information related to the offered service to the locator.

22. The system of claim 15, wherein the electronic device further includes a data store and wherein the locator associates the located advertising information with at least one of the plurality of contexts based on the related service, and stores the advertising information with its associated contexts in the data store.

23. The system of claim 22, wherein the locator locates the matching service by accessing the data store and retrieving matching advertising information stored therein.

24. The system of claim 15, wherein the locator connects the electronic device to the network, listens to the network for advertising information, retrieves such information and determines whether the offered service matches the request and its contexts.

25. A system for locating a service for a handheld electronic device comprising:
a computer system associated with at least one service provider, wherein the computer system is coupled to a network and includes at least one advertiser for transmitting over the network advertising information related to a service offered by each of the at least one service providers;
a gateway server coupled to the network; and
a handheld electronic device that is capable of accessing the gateway server, comprising:
means for specifying a request for a service, wherein the request is related to at least one of a plurality of contexts;
means for transmitting the request to the gateway server; and
a display,
wherein, the gateway server further includes a locator for processing the request and locating advertising information related to the service matching the request and its related context, and wherein the display in the handheld electronic device displays the advertising information related to the matching service such that the advertising information is presented to a user of the handheld device in a manner corresponding to the at least one context.

26. The system of claim 25, wherein the gateway server further includes a data store and wherein the locator associates the located advertising information with at least one of the plurality of contexts based on the related service, and stores the advertising information with its associated contexts in the data store.

27. The system of claim 26, wherein the locator locates the matching service by accessing the data store and retrieving matching advertising information stored therein.

28. The system of claim 25, wherein the locator locates the matching service by listening to the network for advertising information, retrieving such information and determining whether the offered service matches the request and its contexts.

29. The system of claim 25, wherein the locator locates the matching service by issuing the request over the network.
